(19) United States
(12) Patent Application Publication
(10) Pub. No.: US 2013/0264142 A1
(43) Pub. Date: Oct. 10, 2013

(54) COUPLING ELEMENT OF AN ULTRASONIC TRANSDUCER FOR AN ULTRASONIC, FLOW MEASURING DEVICE

(71) Applicants: Beat Kissling, Reinach (CH); Quirin Muller, Munchenstein (CH)

(72) Inventors: Beat Kissling, Reinach (CH); Quirin Muller, Munchenstein (CH)

(73) Assignee: ENDRESS & HAUSER FLOWTEC AG, REINACH (CH)

(21) Appl. No.: 13/995,561

(22) PCT Filed: Nov. 23, 2011
(86) PCT No.: PCT/EP11/70844

§ 371 Date: Jun. 19, 2013

(30) Foreign Application Priority Data
Dec. 20, 2010 (DE) 102010063535.9

(51) Int. Cl. G01F 1/66

(52) U.S. Cl. CPC G01F 1/662
USPC 181/161; 73/861.25

(57) ABSTRACT

A coupling element of an ultrasonic transducer suitable for mode conversion of an acoustic longitudinal wave between an in-coupling surface and an out-coupling surface of the coupling element. The coupling element has a first and second interface with a predetermined medium. A first angle between the in-coupling surface and the first interface and a second angle between the first interface and the out-coupling surface are so selected that a transverse waves fraction is reflected on the first interface to the out-coupling surface. The first angle between the in-coupling surface and the first interface and a third angle between the first interface and the second interface are so selected that a longitudinal wave fraction is reflected on the first interface for second interface. A fraction of the longitudinal waves reflected to the second interface is reflected on the second interface back into the coupling element.

The present invention relates to a coupling element of an ultrasonic transducer for an ultrasonic, flow measuring device suitable for mode conversion of an acoustic longitudinal wave between an in-coupling surface and an out-coupling surface of the coupling element by reflection on a first interface of the coupling element with a predetermined medium.

Ultrasonic, flow measuring devices are applied often in process and automation technology. They permit easy determination of volume flow and/or mass flow in a pipeline.

Known ultrasonic, flow measuring devices frequently work according to the Doppler principle or according to the travel-time difference principle. In the travel-time difference principle, the different travel times of ultrasonic pulses are evaluated as a function of flow direction of the liquid. For this, ultrasonic pulses are sent at a certain angle to the tube axis both in, as well as also counter to, the flow direction. From the travel-time difference, the flow velocity, and therewith, in the case of known diameter of the pipeline cross section, the volume flow, can be determined.

In the Doppler principle, ultrasonic waves are in-coupled into the liquid with a certain frequency and the ultrasonic waves reflected by the liquid are evaluated. From the frequency shift between the coupled and reflected waves, likewise the flow velocity of the liquid can be determined. Reflections in the liquid occur, when small air bubbles or impurities are present therein, so that this principle mainly finds application in the case of contaminated liquids.

The ultrasonic waves are produced, respectively received, using ultrasonic transducers. For this, ultrasonic transducers are secured in the tube wall of the relevant pipeline section. Clamp-on, ultrasonic, flow measuring systems provide another option. In this case, the ultrasonic transducers are pressed externally against the wall of the measuring tube. A great advantage of clamp-on ultrasonic, flow measuring systems is that they do not contact the measured medium and can be placed on an already existing pipeline.

Another ultrasonic, flow measuring device, which works according to the travel-time difference principle, is known from U.S. Pat. No. 5,052,230. The travel time is, in such case, ascertained by means of short ultrasonic pulses, so-called bursts.

Ultrasonic transducers are composed, normally, of an electromechanical transducer element, e.g. a piezoelectric element, and a coupling layer, also called a coupling element, especially in the case of clamp-on-systems. Produced in the electromechanical transducer element are the ultrasonic waves, which are led via the coupling element to the pipe wall and from there into the liquid, in the case of clamp-on systems, or, in the case of inline systems, via the coupling layer into the measured medium. In such case, the coupling layer is, at times, also referred to as a membrane.

Arranged between the piezoelectric element and the coupling element can be another coupling layer, a so called adapting, or matching, layer. The adapting, or matching, layer performs, in such case, the function of transmitting the ultrasonic signal and simultaneously the reduction of a reflection on interfaces between two materials caused by different acoustic impedances.

In order to minimize disturbing reflections of the ultrasonic signal within the coupling element, a sound absorbing region is provided, for example, in DE 10 2007 062 913 A1.

U.S. Pat. No. 4,467,659 discloses a coupling element for an ultrasonic transducer of a flow measuring device. The coupling element has an in-coupling surface, against which a piezoelectric ultrasonic transducer is placed, which produces a longitudinal sound wave in the coupling element. This is so reflected on a first interface that a transverse sound wave is reflected from the first interface to an out-coupling surface, where it is out-coupled from the coupling element into a tube, or pipe, wall, against which the coupling element is placed. The described mode conversion in the coupling element is performed, in order to produce so called Lamb waves in the tube, or pipe, wall, with the assistance of which the flow of a measured medium through the pipe is measured. Additionally, U.S. Pat. No. 4,475,054 discloses a curved interface for focussing the converted transverse wave. These transducers seem unsuitable for classical travel-time difference measurement by means of clamp-on ultrasonic transducers, since, besides the transverse waves, also longitudinal waves are out-coupled into the tube, or pipe, wall, which disturb the measuring.

An object of the invention is to provide an ultrasonic, flow measuring device that couples maximum sound energy of a predetermined form into a pipeline, in order to utilize such for measuring flow.

The object is achieved by the features of independent claims 1 and 12. Further developments and embodiments of the invention are provided in the features of the respective dependent claims.

Besides coupling as much sound energy as possible in a predetermined form into a pipeline, in order to utilize such for measuring flow, in the case of application of a coupling element of the invention, supplementally as little sound energy as possible is in-coupled into the pipeline in other forms disturbing the measuring. The coupling element of the invention is suited for use in high temperature, clamp-on, ultrasonic, flow measuring devices.

The invention can be provided in numerous forms of embodiment. Some thereof will now be explained in greater detail based on the figures of the drawing. Equal elements are provided in the figures with equal reference characters. The figures of the drawing show as follows:

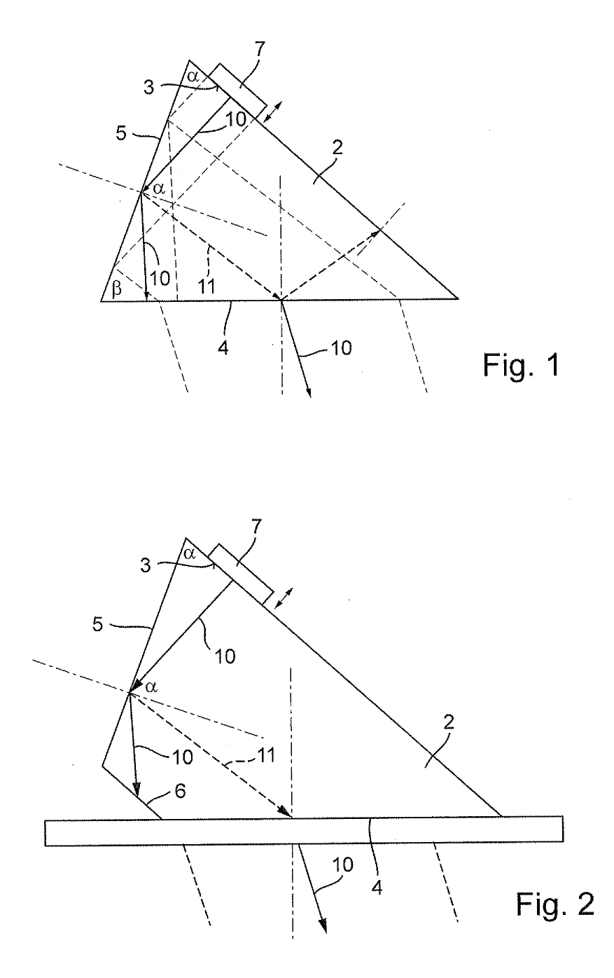

FIG. 1 a cross section through a conventional ultrasonic transducer of a clamp-on ultrasonic, flow measuring device,

FIG. 2 a cross section through an ultrasonic transducer of the invention for a clamp-on ultrasonic, flow measuring device,

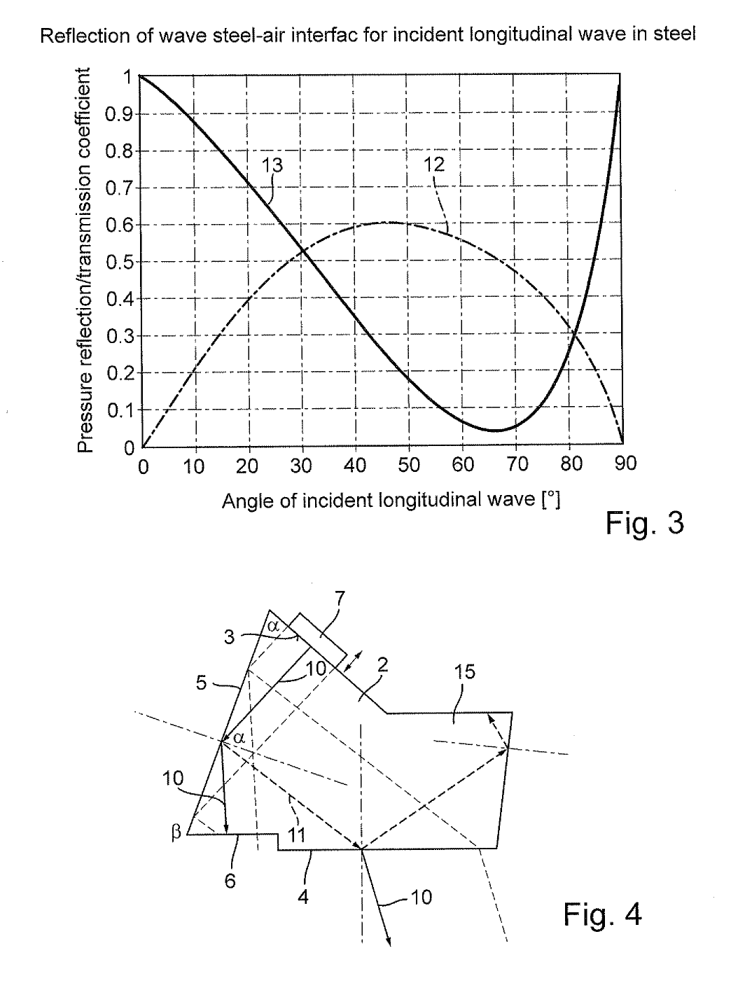

FIG. 3 a graph of reflection coefficients for longitudinal and transverse waves as a function of angle of reflection,

FIG. 4 a cross section through an additional embodiment of an ultrasonic transducer of the invention,

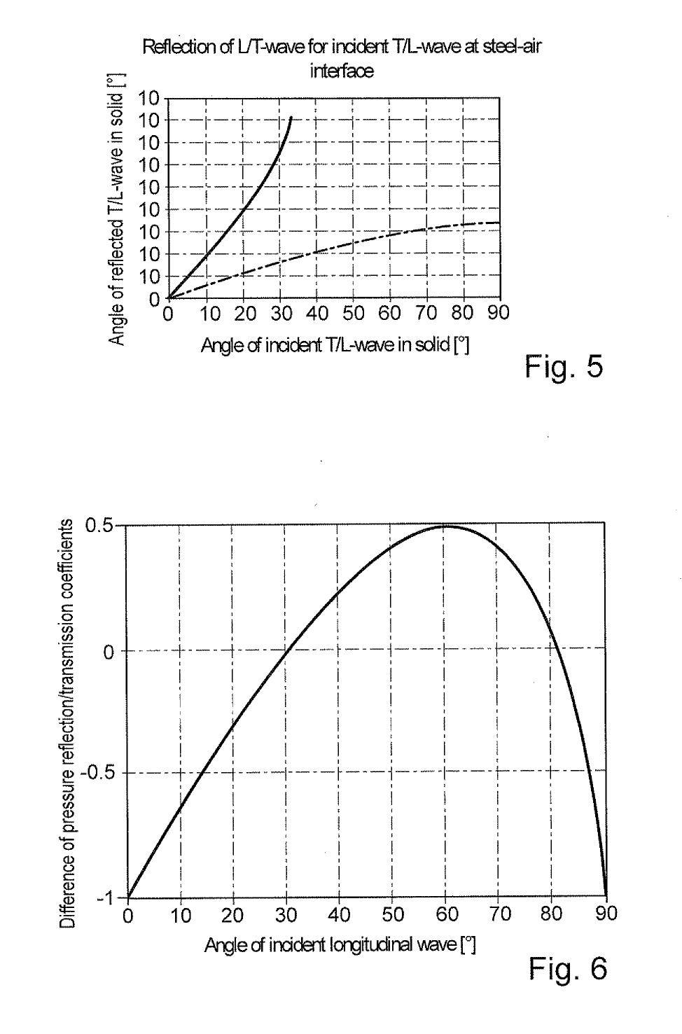

FIG. 5 a graph of angle of reflection of the longitudinal and transverse waves as a function of angle of incidence, and

FIG. 6 a graph of difference of reflection coefficients for longitudinal and transverse waves as a function of angle of reflection.

FIG. 1 shows an ultrasonic transducer 1 of a clamp-on ultrasonic, flow measuring device of the state of the art. Ultrasonic transducer 1 includes a coupling element 2, which is suitable for mode conversion of an acoustic longitudinal wave between an in-coupling surface 3 and an out-coupling surface 4 of the coupling element by reflection on a first interface 5 of the coupling element 2 with a predetermined medium. These coupling elements of ultrasonic transducers for ultrasonic, flow measuring devices for transmission of mechanical, especially acoustic, waves are well known. In such case, there occurs, supplementally to the transmission of the acoustic waves, also a mode conversion. An electromechanical transducer element 7 is arranged on the in-coupling surface 3 of the coupling element 2. It produces longitudinal sound waves 10, which propagate in the coupling element 2 toward a first interface 5. The dashed lines show the width of the wave. The first interface 5 is formed by a surface of the coupling element 2 with a predetermined medium, such as, for example, the air in the environment of the coupling element 2.

At the first interface 5, the longitudinal wave 10 is reflected. As a function of the velocities of sound in the coupling element 2 and in the medium adjoining the surface 5 of the coupling element 2 and as a function of the incident angle of the longitudinal wave 10 on the first interface 5, respectively the first angle α between the in-coupling surface 3 and the first interface 5, a transverse wave 11 is produced via a mode conversion in the coupling element 2. The incoming longitudinal wave 10 is thus partially reflected as a longitudinal wave 10 and partially as a transverse wave 11 on the first interface 5 of the coupling element 2. Their relative fractions depend, in turn, on the above stated parameters. A part of the sound energy of the incoming longitudinal wave 10 can also escape from the coupling element 2, in the form of a sound wave. Here and in the following, no further attention will be given to the fractions, which escape from the system.

The reflected longitudinal wave 10 and the reflected transverse wave 11 propagate at different angles. Both strike the out-coupling surface 4 of the coupling element 2. There, they are, again proportionately, out-coupled from the coupling element 2 and in-coupled into a measured medium, or into the wall 9 of a measuring tube 8, and, from the wall 9, then into the measured medium. A problem with this ultrasonic transducer is that, besides the fractions of the transverse waves, which are used for measuring the flow of the measured medium through the measuring tube 8 and which are, in turn, reflected at the out-coupling surface 4 or the measuring tube wall 9 as longitudinal waves into the measured medium, also the longitudinal waves reflected to the out-coupling surface are reflected at the out-coupling surface 4 or the measuring tube wall 9 into the measured medium or propagate in the measuring tube wall 9 and are perceived as disturbance during the measuring of the flow of the medium through the measuring tube.

A coupling element 2 of the invention for an ultrasonic transducer of an ultrasonic, flow measuring device, as such is shown in a first embodiment in FIG. 2, includes an in-coupling surface 3 and an out-coupling surface 4 and is suitable for mode conversion of an acoustic longitudinal wave between the in-coupling surface 3 and the out-coupling surface 4 of the coupling element 2 by reflection on a first interface 5 of the coupling element with a predetermined medium. Along with that, it includes, however, yet an additional, second interface 6 with a predetermined medium. Interface 6 is not the same as the out-coupling surface 4 of the coupling element 2.

In the case of application of the coupling element 2 of the invention, as already above described, a longitudinal wave 10 is in-coupled through the in-coupling surface 3 into the coupling element 2 to propagate to the first interface 5, where it is reflected. The fractions of the reflected transverse wave 11 and reflected longitudinal wave 10 depend, in turn, to a first approximation, on the above stated parameters, which are correspondingly set. Thus, a first angle α between the in-coupling surface 3 and the first interface 5 and a second angle β between the first interface 5 and the out-coupling surface 4 are so selected that a transverse waves 11 fraction is reflected on the first interface 5 to the out-coupling surface 5. Moreover, a third angle γ between the first interface 5 and the second interface is so selected that a possible part of the longitudinal waves 10 reflected to the second interface 6 is reflected at the second interface 6 back into the coupling element 2. If the second interface 6 is so arranged relative to the first interface 5 that a longitudinal waves 10 fraction is reflected on the first interface 5 to the second interface 6, then the second interface 6 is also so arranged relative to the first interface 5 that a fraction of these longitudinal waves 10 is reflected on the second interface 6 back into the coupling element 2. Reflected on the second interface 6 are, in such case, not exclusively longitudinal waves 10 back into the coupling element 2. In a preferred embodiment of the invention, however, the fraction of a predetermined wave type, for example, longitudinal waves, of the back reflected waves is large in comparison to the fraction of the complementary wave type, for example, transverse waves.

The second interface 6 has, in such case, a center of area, which, relative to an imaginary plane, is offset in the direction of a surface normal to the out-coupling surface 4, which surface normal extends through the center of area of the out-coupling surface. The imaginary plane is oriented in space in such a manner that the surface normal of the out-coupling surface 4 intersects the plane perpendicularly. Additionally, the center of area of the out-coupling surface lies in said plane. In this way, it is unequivocally established that the second interface 6 does not belong to the out-coupling surface 4. The out-coupling surface 4 in the mounted state of the ultrasonic transducer 1 contacts, for example, a pipeline, or in the case of a mounted flow measuring device of the invention, a measuring tube, in order to couple the ultrasonic waves into the measuring tube. The second interface 6 does not contact the measuring tube, in order that the ultrasonic waves reflected on it are not coupled into the measuring tube. In the example of an embodiment of the invention illustrated here, the second interface 6 is formed by cutting a corner off the coupling element 2 of FIG. 1. The resulting structural feature, where the coupling element turns away from the out-coupling surface 4, is referred to herein as a stand-off.

Besides the angles, naturally also the said surfaces 3, 4, 5 and 6 are correspondingly formed, especially as regards their size, however, also as regards their shapes. Thus there result predetermined positions of the surfaces relative to one another. In an embodiment of the invention, especially the longitudinal waves 10 coupled through the in-coupling surface 3 strike neither unreflected on the second interface 6 of the stand-off nor on the out-coupling surface 4. Often, out-coupling surfaces are also referred to as ultrasound windows.

As already mentioned, the individual reflections are to a first approximation independent of the wavelengths of the acoustic, transverse- or longitudinal waves. Therefore, a coupling element of the invention can also be designed independently of an ultrasonic transducer or an ultrasonic measuring system. If, however, a system should measure highly precisely, then other parameters, such as e.g. amplitude, wavelength and/or frequency of the acoustic wave coupled into the coupling element, the acoustic impedances of the participating substances, such as that of the electromechanical transducer element, that of the coupling element, that of a possibly interposed adapting, or matching, layer, that of the medium surrounding the doupling element, that of the measuring tube and that of the measured medium or other parameters in the structural embodiment of a coupling element of the invention, can be taken into consideration.

To this point, only the path of an acoustic wave from the electromechanical transducer element to the measured medium has been described. For those skilled in the art, however, it will be clear, from what has been said above, that an ultrasonic transducer of the invention can serve both as transmitter and as receiver.

Thus, not only can an acoustic wave be out-coupled from the out-coupling surface of the coupling element. Rather, the out-coupling surface can also be utilized to couple an acoustic wave into the coupling element. Analogous considerations hold naturally also for the in-coupling surface and for the first interface. And, the electromechanical transducer element is also suitable for transducing an acoustic wave into an electrical signal.

In the case of application of a coupling element of the invention in an ultrasonic transducer as receiver, for example, the first angle between the in-coupling surface and the first interface and the second angle between the first interface and the out-coupling surface can be so selected and, in the mounted and therewith oriented state of an ultrasonic, flow measuring device of the invention, for example, acoustic waves can be so coupled into the coupling element through the out-coupling surface that a fraction of the acoustic waves coupled through the out-coupling surface is reflected as transverse waves to the first interface, and a fraction of the transverse waves reflected to the first interface are reflected at the first interface as longitudinal waves to the in-coupling surface.

In a further development of the coupling element 2 of the invention, the first angle α between the in-coupling surface 3 and the first interface 5 and the third angle γ between the first interface 5 and the second interface 6 are so selected that the energy of the fraction of the transverse waves reflected on the first interface 5 to the second interface 6 is smaller than the energy of the fraction of the longitudinal waves reflected on the first interface 5 to the out-coupling surface 4, and/or the angles α and γ0 are so selected that the energy of the fraction of the longitudinal waves 10 reflected on the first interface 5 to the second interface 6 is essentially greater than the energy of the fraction of the longitudinal waves reflected on the first interface 5 to the out-coupling surface 4.

The transverse waves fraction reflected from the first interface to the second interface is very small. In FIG. 2, the second interface 6 extends approximately parallel to the fraction of the transverse wave 11 reflected from the first interface 5 to the out-coupling surface 4 and, therewith, the energy of the fraction of the acoustic transverse waves reflected on the first interface 5 to the second interface 6 is virtually zero, since practically no transverse waves 11 are reflected from the first interface 5 to the second interface 6. The longitudinal waves 10 reflected from the first interface 5 are practically completely reflected on the second interface 6 and, thus, approximately none of the longitudinal waves 10 reflected from the first interface 5 strikes directly on the out-coupling surface 4.

Correspondingly, the fraction of the transverse waves reflected from the first interface to the out-coupling surface is high, here approximately 100%.

In an additional further development of the invention, the angle α is so selected that the amplitude of the longitudinal waves 10 reflected on the first interface 5, thus the longitudinal wave 10 reflected to the second interface 6 and/or reflected to the out-coupling surface 4, lies at least 10 dB, especially at least 20 dB, under the level of the amplitude of the transverse waves 11 reflected on the first interface 5, thus the transverse waves 11 arising from mode conversion and reflected to the second interface 6 and/or reflected to the out-coupling surface 4. The angle γ is then, for example, so selected that the energy of the longitudinal wave reflected on the second interface 6 back into the coupling element 2 is minimal, i.e. that a reflection coefficient for this reflection has a global minimum at the selected angle γ.

For each of the described reflections, a reflection coefficient can be calculated. Plotted in FIG. 3 as a function of incident angle are the reflection coefficients 12 and 13, respectively, for transverse and longitudinal wave. The angle of incidence ranges between 0° and 90° and is measured between the incoming wave, here, for example, the longitudinal wave 10, and the normal vector to the interface, here, for example, the first interface 5. When it is assumed that the longitudinal wave 10 is coupled into the coupling element 2 perpendicularly to the in-coupling surface 3 and correspondingly propagates to the first interface 5 perpendicularly to the in-coupling surface 3, then the angle of incidence equals the first angle α between in-coupling surface 3 and first interface 5. The angles of reflection of the transverse wave 11 and longitudinal wave 10 reflected on the first interface 5 result then correspondingly from the formulas for reflection. FIG. 5 shows a graph of the angle of reflection of the longitudinal and transverse waves as a function of the angle of incidence of the longitudinal, respectively transverse, wave at a first interface formed of a stainless steel as material of the coupling element and air as the medium surrounding the coupling element in the region of the first interface. The right, relatively flat curve shows the transverse (T) reflection of an incoming longitudinal wave (L), while the left, more steeply rising curve shows the longitudinal (L) reflection of an incoming transverse wave (T).

The graph of FIG. 3 also concerns this pairing of materials, whereby other pairings of materials should not be excluded thereby. The reflection coefficient is also, at times, called the reflection factor. It is a measure for the reflected amplitude of the reflected wave and therewith a measure for the reflected energy or therefrom derived variables, such as, for example, the sound intensity. In the present example, the longitudinal wave in the case of an angle of incidence of 0° is reflected completely as a longitudinal wave 10. The first interface 5 would then extend parallel to the in-coupling surface 3. A value for reflection on the first interface 5 for the angle of incidence of 90° does not exist logically, since the longitudinal wave propagating from the in-coupling surface 3 would not strike the first interface 5, since the two would extend parallel to one another. These facts hold naturally also for the second reflection on the second interface 6 or any other reflection. The figure is explained here only by way of example based on the first reflection.

A transverse wave 11 would in the case of the selected first interface 5 an angle of 45° be reflected with an amplitude of about 0.6-times the incoming longitudinal wave. This represents the global maximum of the curve of the reflection coefficient of the reflected transverse wave 11 plotted versus the angle of incidence. The global minimum of the curve of the reflection coefficient of the reflected longitudinal wave 11 plotted versus the angle of incidence lies here at about 66°. Then, only about 0.04-times the energy of the longitudinal wave incoming on the first interface 5 is reflected as longitudinal wave 10.

The first interface 5 and the first angle α are formed according to a further development of the invention in such a manner that a first curve 12 of a plotted reflection factor of the wave reflected as transverse wave 11 versus the first angle α exists with a global maximum and correspondingly a second curve of a reflection factor of the wave reflected as longitudinal wave 10 plotted versus the first angle α exists with a global minimum, wherein the first curve intersects the second curve at two points.

In a further development of the invention, the first angle α between the in-coupling surface and the first interface is so selected between 0° and 90° that it lies between the angular values of the two intersections of the curves of the respective reflection factors 12 and 13 of the longitudinal wave reflected on the first interface and the transverse wave reflected on the first interface plotted versus the first angle.

In an additional further development of the invention, the first angle between the in-coupling surface and the first interface is so selected between 0° and 90° that it lies between the angular value of the global minimum of the curve 13 of the reflection factor of the longitudinal wave reflected on the first interface plotted versus the first angle and the angular value of the global maximum of the curve 12 of the reflection factor of the transverse wave reflected on the first interface plotted versus the first angle.

These limits are guidelines for those skilled in the art. Depending on the character of the curves, the slopes of the curves around the described points can be very small or a local minimum or maximum can be located in the direct vicinity. In such case, these limits can be exceeded, in order to manufacture a coupling element of the invention.

In an additional further development of the invention, it is provided that the first angle between the in-coupling surface and the first interface between 0° and 90° corresponds to the angular value of the global maximum of a curve of the difference as a function of the first angle of the curve of the reflection factor of the transverse wave reflected on the first interface plotted versus the first angle and the curve of the reflection factor of the longitudinal wave reflected on the first interface plotted versus the first angle.

If, thus, the difference between the FIG. 3 plotted, reflection factors for the reflected transverse wave and the the reflected longitudinal wave is formed continuously between the limits 0° and 90° and the obtained curve, in turn, plotted versus the angle of incidence between the limits 0° and 90°, this curve has a global maximum, here at an angle of incidence of about 62°. The coupling element 2 is thus constructed such that the first angle α between the in-coupling surface 3 and the first interface 5 amounts to about 62°. A graph of the difference plotted versus the angle α is shown in FIG. 6.

In a form of embodiment, the first angle between the in-coupling surface and the first interface is so selected between 0° and 90° that it corresponds to the angular value of the global maximum of the curve of the reflection factor of the transverse wave reflected on the first interface plotted versus the first angle. Alternatively thereto, the first angle between the in-coupling surface and the first interface is so selected between 0° and 90° that it corresponds to the angular value of the global minimum of the curve of the reflection factor of the longitudinal wave reflected on the first interface plotted versus the first angle. Depending on the material of the coupling element and the material of the adjoining medium and depending on angle of incidence of the acoustic wave, the maximum of the one and the minimum of the other reflection can also coincide.

As already mentioned, similar relationships hold for reflections on the second interface 6 and on the out-coupling surface 4. The second angle between the first interface 5 and the out-coupling surface 4 is correspondingly selected.

A further development of the invention provides that the angle γ in the case of predetermined α is chosen such that the energy of the longitudinal wave 10 reflected on the second interface 5 back into the coupling element 2 is minimal, i.e. that the angles α and γ are so selected that the angular value of γ corresponds to the angular value of the global minimum of the curve of the reflection factor of the longitudinal wave 10 reflected on the second interface 5 plotted versus the angle γ. If, for example, the angle α is so selected that it corresponds to the angular value of the global minimum of the curve of the reflection factor of the longitudinal wave 10 reflected on the first interface 5 plotted versus the first angle, then also the third angle γ is so selected that the angle of incidence of the longitudinal wave reflected on the first interface 5 to the second interface 6 equals a on the second interface 6.

A coupling element of the invention is used e.g. in ultrasonic transducers of industrial process measurements technology for high temperature applications, thus, for example, when the measured medium has a temperature greater than 150° C. or even greater than 200° C., and the outside of the pipeline, on which the coupling element is placed, has a similarly high temperature. For such purpose, it advantageous that the coupling element then at least partially comprises a metal or a metal alloy, especially steel, alloyed steel or a stainless steel. However, also other materials provide options, such as, for example, synthetic materials or ceramics. For example, it is desired that longitudinal waves be coupled into the measured medium, for example, via a steel tube, at an angle required for a travel-time difference measurement, with a corresponding angle of incidence of the transverse waves on the out-coupling surface lying, for example, between 15° and 75°. This angle can be adjusted especially via the transverse velocity of sound in the coupling element, whose material is, thus, to be correspondingly selected. The temperature resistance of the material is taken into consideration as another boundary condition for its selection.

In an example of an embodiment, the ratio of longitudinal to transverse velocity of sound in the material of the coupling element lies between 0.5 and 0.6, especially between 0.54 and 0.57, for example, at about 0.56.

An ultrasonic transducer of the invention includes at least one coupling element of the invention, wherein an electromechanical transducer element 7 is arranged on the in-coupling surface of the coupling element. The ultrasonic transducer can have a housing around the coupling element 2. Between the housing and the coupling element, there is then a medium surrounding the coupling element, for example, a gas, a liquid or a synthetic material, or else the housing provides the material for forming one or both interfaces. An ultrasonic transducer of the invention is suitable for application in an ultrasonic, flow measuring device, especially in a clamp-on, ultrasonic, flow measuring device. The electromechanical transducer element 7 is, for example, a piezoelectric element. In one embodiment, such is a so-called thickness oscillator. The electromechanical transducer element 7 is operated in the thickness mode, whereby it produces mechanical, especially acoustical, longitudinal waves in the coupling element. In any case, the electromechanical transducer element 7 must be suitable for coupling mechanical waves, especially longitudinal sound waves, through the in-coupling surface into the coupling element.

A clamp-on, ultrasonic, flow measuring device of the invention includes at least one ultrasonic transducer of the invention, and, for travel-time difference measurements, at least two ultrasonic transducers of the invention. The two ultrasonic transducers of a so equipped, clamp-on, ultrasonic, flow measuring device can be arranged on a pipeline, which makes it then a measuring tube, in established ways. In such case, the out-coupling surface is placed in contact, and acoustically coupled, with the pipeline.

In such case, the out-coupling surface can be mounted directly on the outer surface of the pipeline, whereby their materials form an interface, or the out-coupling surface is mounted on the pipeline with interpositioning of a coupling mat of a predetermined material, thus a material especially with known velocities of sound both for a transverse as well as also for a longitudinal, sound wave. Another option is to place between the out-coupling surface and the pipeline a coupling paste, or grease. Coupling mats are usually of a silicone material. It could, however, also be a soft metal or a metal alloy, such as, for example, alloyed steel or stainless steel.

If the coupling element comprises the same material as the pipeline or a material with acoustically similar properties, then the influence of the interface formed between out-coupling surface and measuring tube wall is negligible, since sound is passed through virtually without reflection. Otherwise, also these interfaces must be taken into consideration in the design of the coupling element, especially the interface formed between measuring tube wall and measured medium. Since acoustic transverse waves do not, or only very slightly, propagate in liquids and gases and such thus cannot be utilized for measuring flow by means of the travel-time difference principle, the transverse waves are coupled as longitudinal waves into the measured medium. A reflection as longitudinal waves is also possible, for example, in the case of the transition from the coupling element into a coupling mat or into the measuring tube. If, however, measuring tube and coupling element have equal or similar acoustic properties, then the transverse waves are only reflected as longitudinal waves at the transition into the medium. Thus, the least energy is lost in this case.

The material of the pipeline, or at least its acoustic properties, such as its acoustic impedance or velocity of sound, is, consequently, advantageously known. The same holds for the measured medium.

FIG. 4 shows another form of embodiment of a coupling element 2 of the invention. The stand-off is here so embodied that the second interface 6 lies in a plane parallel to the plane of the out-coupling surface 4 and is offset in the direction of the normal vector of the plane of the out-coupling surface 4. The longitudinal and/or transverse mechanical waves, which are reflected back into the coupling element, are reflected into a region 15 of the coupling element having high attenuation of longitudinal and/or transverse mechanical waves. Especially, reflected into this sound absorbing region of the coupling element 2 are the longitudinal waves reflected by the second interface and/or the longitudinal and/or transverse waves reflected by the out-coupling surface. Additionally or alternatively thereto, the longitudinal and/or transverse waves, which are reflected back into the coupling element, especially thus the longitudinal waves reflected back on the second interface, are reflected on a third interface, especially reflected approximately perpendicularly on the third interface, where they escape from the coupling element 2 without further reflection back into the coupling element 2. In that case, a total passing of the waves through the interface would be present. Also, already a large fraction of the longitudinal waves 10 striking the second interface 6 can escape from the coupling element 2 by reflection to the outside.

The structure shown in FIG. 4 leads to the fact that the longitudinal waves 10 reflected to the second interface 6 are to a certain fraction reflected back to the first interface 5 and from there, in turn, to a large extent reflected back to the in-coupling surface 3 and to the electromechanical transducer element 7. These longitudinal waves 10 can disturb and, thus, be disadvantageous for, the actual measuring. However, from the travel time of these acoustic waves reflected to the in-coupling surface 3 and therewith to the electromechanical transducer element 7, the temperature in the coupling element 2 can be calculated. The state of the art describes the calculating of temperature already at length.

In an embodiment, the second interface is curved. In this way, the waves reflected in the coupling element on the second interface can be focused back to the sound damping region of the coupling element, whereby the coupling element can be made smaller. In an additional embodiment, the first interface is curved, especially it is so curved that the transverse waves reflected from the first interface to the out-coupling surface are focused toward the out-coupling surface. Naturally, also the out-coupling surface can be curved, in order, for example, to focus the sound waves into the measured medium in the pipeline or in order to match them to the surface of the pipeline.

### LIST OF REFERENCE CHARACTERS

1 ultrasonic transducer
2 coupling element
3 in-coupling surface
4 out-coupling surface
5 first interface
6 second interface
7 electromechanical transducer element
8 measuring tube
9 measuring tube wall
10 longitudinal wave
11 transverse wave
12 curve of the reflection coefficient of the transverse wave
13 curve of the reflection coefficient of the longitudinal wave
15 sound damping region

1-14. (canceled)

15. A coupling element of an ultrasonic transducer for an ultrasonic, flow measuring device suitable for mode conversion of an acoustic longitudinal wave between an in-coupling surface and an out-coupling surface of the coupling element by reflection on a first interface of the coupling element with a predetermined medium, wherein:
the coupling element has a second interface with a predetermined medium; a first angle between the in-coupling surface and the first interface and a second angle between the first interface and the out-coupling surface are so selected that a transverse waves fraction is reflected on the first interface to the out-coupling surface;
the first angle between the in-coupling surface and the first interface and a third angle between the first interface and the second interface are so selected that a longitudinal waves fraction is reflected on the first interface to the second interface, and that a fraction of the longitudinal waves reflected to the second interface is reflected on the second interface back into the coupling element; and
the center of area of the second interface is offset in the direction of the surface normal of the out-coupling surface through the center of area of the out-coupling surface relative to a plane, to which the surface normal of the out-coupling surface is perpendicular and in which the center of area of the out-coupling surface lies.

16. The coupling element of an ultrasonic transducer for an ultrasonic, flow measuring device as claimed in claim 15, wherein:
the first angle between the in-coupling surface and the first interface and the third angle between the first interface and the second interface are so selected that the energy of the fraction of the transverse waves reflected on the first interface to the second interface is essentially smaller than the energy of the fraction of the transverse waves reflected on the first interface to the out-coupling surface.

17. The coupling element of an ultrasonic transducer for an ultrasonic, flow measuring device as claimed in claim 15, wherein:
the third angle between the first interface and the second interface is so selected that the second interface extends parallel to the fraction of the transverse wave reflected from the first interface to the out-coupling surface.

18. The coupling element of an ultrasonic transducer for an ultrasonic, flow measuring device as claimed in claim 15, wherein:
the first angle between the in-coupling surface and the first interface is so selected that it lies between the angular values of two intersections of curves plotted versus the first angle for the respective reflection factors of the longitudinal wave reflected on the first interface and the transverse wave reflected on the first interface.

19. The coupling element of an ultrasonic transducer for an ultrasonic, flow measuring device as claimed in claim 15, wherein:
the first angle between the in-coupling surface and the first interface is so selected that it lies between the angular value of the global minimum of the curve of the reflection factor of the longitudinal wave reflected on the first interface plotted versus the first angle and the angular value of the global maximum of the curve of the reflection factor of the transverse wave reflected on the first interface plotted versus the first angle.

20. The coupling element of an ultrasonic transducer for an ultrasonic, flow measuring device as claimed in claim 18, wherein:
the first angle between the in-coupling surface and the first interface corresponds to the angular value of the global maximum of a curve plotted versus the first angle for the difference between the curve of the reflection factor of the transverse wave reflected on the first interface plotted versus the first angle and the curve of the reflection factor of the longitudinal wave reflected on the first interface plotted versus the first angle.

21. The coupling element of an ultrasonic transducer for an ultrasonic, flow measuring device as claimed in claim 15, wherein:
the first angle between the in-coupling surface and the first interface is so selected that it corresponds to the angular value of the global maximum of the curve of the reflection factor of the transverse wave reflected on the first interface plotted versus the first angle.

22. The coupling element of an ultrasonic transducer for an ultrasonic, flow measuring device as claimed in claim 15, wherein:
the first angle between the in-coupling surface and the first interface is so selected that it corresponds to the angular value of the global minimum of the curve of the reflection factor of the longitudinal wave reflected on the first interface plotted versus the first angle.

23. The coupling element of an ultrasonic transducer for an ultrasonic, flow measuring device as claimed in claim 15, wherein:
the coupling element at least partially comprises a metal or a metal alloy.

24. The coupling element of an ultrasonic transducer for an ultrasonic, flow measuring device as claimed in claim 15, wherein:
the first interface is curved and/or the second interface is curved.

25. An ultrasonic transducer for an ultrasonic, flow measuring device having an electromechanical transducer element, which is arranged on an in-coupling surface of a coupling element, wherein the coupling element is a coupling element of an ultrasonic transducer for an ultrasonic, flow measuring device suitable for mode conversion of an acoustic longitudinal wave between an in-coupling surface and an out-coupling surface of the coupling element by reflection on a first interface of the coupling element with a predetermined medium, wherein: the coupling element has a second interface with a predetermined medium; a first angle between the in-coupling surface and the first interface and a second angle between the first interface and the out-coupling surface are so selected that a transverse waves fraction is reflected on the first interface to the out-coupling surface; the first angle between the in-coupling surface and the first interface and a third angle between the first interface and the second interface are so selected that a longitudinal waves fraction is reflected on the first interface to the second interface, and that a fraction of the longitudinal waves reflected to the second interface is reflected on the second interface back into the coupling element; and the center of area of the second interface is offset in the direction of the surface normal of the out-coupling surface through the center of area of the out-coupling surface relative to a plane, to which the surface normal of the out-coupling surface is perpendicular and in which the center of area of the out-coupling surface lies.

26. The use of an ultrasonic, flow measuring device having a coupling element of an ultrasonic transducer for an ultrasonic, flow measuring device suitable for mode conversion of an acoustic longitudinal wave between an in-coupling surface and an out-coupling surface of the coupling element by reflection on a first interface of the coupling element with a predetermined medium, wherein: the coupling element has a second interface with a predetermined medium; a first angle between the in-coupling surface and the first interface and a second angle between the first interface and the out-coupling surface are so selected that a transverse waves fraction is reflected on the first interface to the out-coupling surface; the first angle between the in-coupling surface and the first interface and a third angle between the first interface and the second interface are so selected that a longitudinal waves fraction is reflected on the first interface to the second interface, and that a fraction of the longitudinal waves reflected to the second interface is reflected on the second interface back into the coupling element; and the center of area of the second interface is offset in the direction of the surface normal of the out-coupling surface through the center of area of the out-coupling surface relative to a plane, to which the surface normal of the out-coupling surface is perpendicular and in which the center of area of the out-coupling surface lies, wherein:
the coupling element is placed directly, or with interpositioning of at least one predetermined coupling material, on a pipeline of a predetermined material for determining the flow a measured medium through the pipeline.

27. The use of an ultrasonic, flow measuring device as claimed in claim 26, wherein:
the coupling element comprises a material with similar acoustic properties as the pipeline.

28. The use of an ultrasonic, flow measuring device as claimed in claim 26, wherein:
the measured medium has a temperature greater than 150° C.
